(19) United States
(12) Patent Application Publication
(10) Pub. No.: US 2012/0092457 A1
(43) Pub. Date: Apr. 19, 2012

(54) STEREOSCOPIC IMAGE DISPLAY APPARATUS

(75) Inventors: Yoichi Sugino, Osaka (JP); Michihiro Yamagata, Osaka (JP); Kenichi Hayashi, Nara (JP); Shinji Yamaguchi, Osaka (JP); Keiki Yoshitsugu, Hyogo (JP)

(73) Assignee: PANASONIC CORPORATION, Osaka (JP)

(21) Appl. No.: 13/240,630

(22) Filed: Sep. 22, 2011

(30) Foreign Application Priority Data
Oct. 19, 2010 (JP) 2010-234315
Jun. 14, 2011 (JP) 2011-131722

(51) Int. Cl. H04N 13/02

(52) U.S. Cl. 348/46; 348/E13.026

(57) ABSTRACT

A display apparatus 100 of the present invention includes: a memory 130; a display 101; an operation part 110; and a controller 150. The controller 150 controls the display 101, in the case where the image of image data acquired in the memory 130 is displayed as a stereoscopic image, such that the image of the image data acquired in the memory 130 is displayed as a planar image when an instruction for selection becomes receivable by the operation part 110.

### FIELD OF THE INVENTION

The present invention relates to a stereoscopic image display apparatus.

### BACKGROUND OF THE INVENTION

In recent years, various stereoscopic image display apparatuses have been proposed and developed. For example, Japanese Patent Laid-Open No. 2005-267655 discloses a content reproducing apparatus that can reproduce stereoscopically viewable contents.

### DISCLOSURE OF THE INVENTION

If a stereoscopic image can be partially extracted and the extracted image can be synthesized with another stereoscopic image, users can be more entertained.

Unfortunately, as will be described below, it is difficult to naturally select any region from a stereoscopic image.

A stereoscopic image is displayed with an illusion of a three-dimensional depth on a display screen. A user of a display apparatus cannot directly touch such a stereoscopic image with a hand and thus it is difficult to correctly point at any region of the stereoscopic image. Particularly, display contents viewed in the rear on the display screen cannot be selected.

Selection display including pointers and frames may be used to select any region of a stereoscopic image. However, such selection display does not include a parallax amount, so that it is not easy to naturally superimpose the selection display on the stereoscopic image during the selection of any region of the stereoscopic image. For example, in the case where selection display is always provided in front of the stereoscopic image, the depth of a region to be selected is not identical to the depth of the selection display, creating a feeling of unnaturalness for a user. In the case where the depth of a region to be selected and the depth of the selection display are identical to each other, depth information has to be calculated for each pixel. Thus the computational complexity may increase or the depth of the selection display may sequentially change with the movement of the selection display, leading to lower visibility.

The present invention has been devised to solve the problem. An object of the present invention is to provide a stereoscopic image display apparatus that easily can select and edit a stereoscopic image.

In order to solve the problem, the stereoscopic image display apparatus of the present invention includes: an acquisition unit that acquires image data; a display unit that displays an image of the acquired image data as one of a stereoscopic image and a planar image; a receiving unit that receives an instruction for selecting a part of the region of the displayed planar image; and a control unit that controls the display unit, in the case where the image of the image data acquired in the acquisition unit is displayed as a stereoscopic image on the display unit, such that the image of the image data acquired in the acquisition unit is displayed as a planar image when the instruction for selection becomes receivable by the receiving unit.

The stereoscopic image display apparatus of the present invention temporarily switches stereoscopic display to planar display when a user selects any region of a stereoscopic image, allowing the user to select any region from a planar image. Thus the user can naturally select any region of the stereoscopic image. In this manner, the user easily can select and edit the stereoscopic image.

### BRIEF DESCRIPTION OF THE DRAWINGS

FIG. 1 is a block diagram showing the configuration of a display apparatus according to a first embodiment;

FIG. 2 is a cross-sectional plan view schematically showing a part of a display panel according to the first embodiment;

FIG. 3A shows that any region of a first image is selected by selection frame display;

FIG. 3B shows that an image extracted from the first image is synthesized at any position of a second image;

FIG. 4 is a flowchart of the selection and extraction of any region from the first image;

FIG. 5 is a flowchart showing the synthesis of the extracted image onto the second image;

FIG. 6 is a block diagram showing the configuration of a display apparatus according to a second embodiment;

FIG. 7A shows that any region of a first image is selected;

FIG. 7B shows that an image extracted from the first image is synthesized at any position of a second image;

FIG. 8 shows an example of an operation screen for adjusting the depth of an image extracted by the display apparatus of the second embodiment;

FIG. 9 is a flowchart of the selection and extraction of any region from the first image;

FIG. 10 is a flowchart of the synthesis of the extracted image on the second image;

FIG. 11 is a flowchart showing the processing of a proximity sensor;

FIG. 12A shows a finger at the start of sliding on a first image according to a third embodiment; and

FIG. 12B shows the finger at the end of sliding on the first image according to the third embodiment.

### DESCRIPTION OF THE EMBODIMENTS

The following will describe embodiments of the present invention in accordance with the accompanying drawings.

### First Embodiment

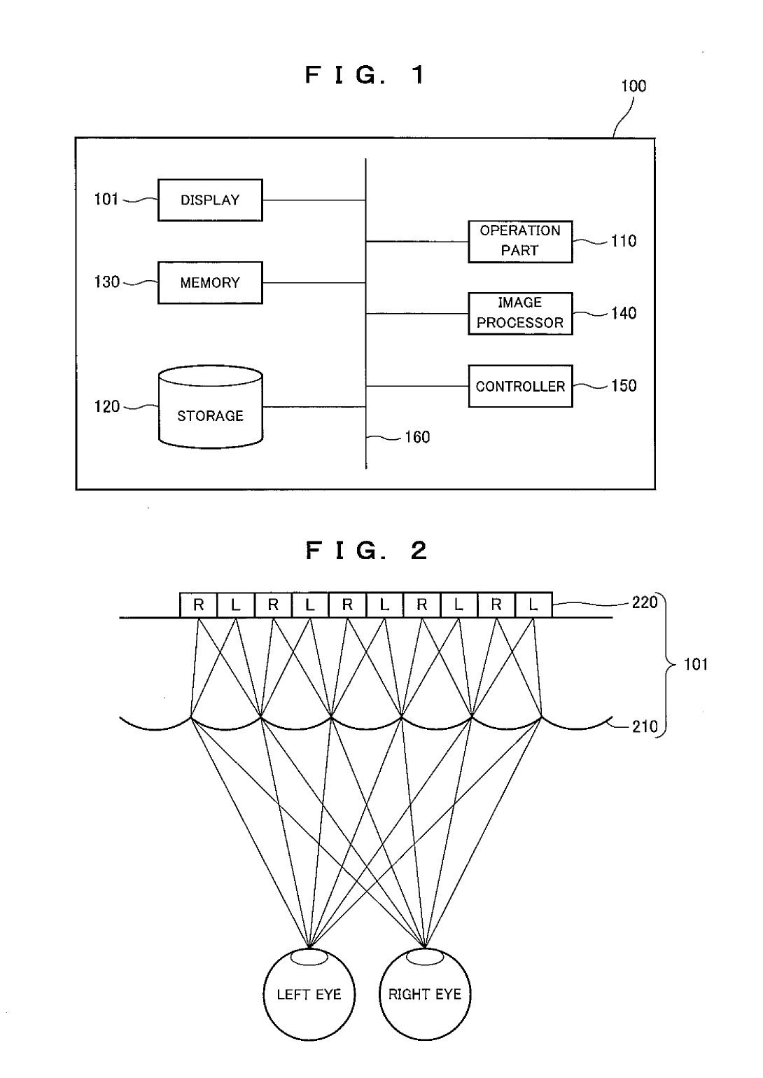

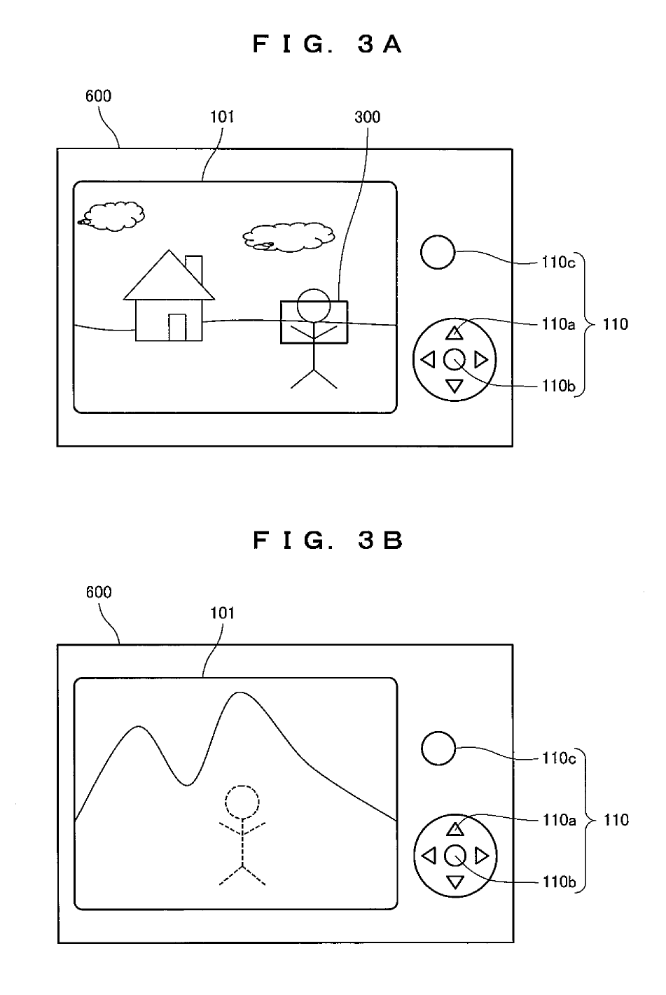

FIG. 1 is a block diagram showing the configuration of a stereoscopic image display apparatus 100 according to a first embodiment. FIG. 2 is a cross-sectional plan view schematically showing a part of a display 101. FIGS. 3A and 3B are schematic diagrams showing edit screens of the stereoscopic image display apparatus 100. In these drawings, the stereoscopic image display apparatus 100 is provided for a digital still camera. The stereoscopic image display apparatus 100 may be also provided for other devices such as smartphones and mobile phones.

The stereoscopic image display apparatus 100 (hereinafter, simply will be referred to as a display apparatus 100) is an apparatus for displaying and editing a stereoscopic image. As shown in FIG. 1, the display apparatus 100 includes the display 101, an operation part 110, a storage 120, a memory 130, an image processor 140, a controller 150, and a bus 160.

The display 101 is capable of displaying an image of image data as a stereoscopic image or a planar image. When displaying a stereoscopic image, the display 101 displays the stereoscopic image based on depth information contained in image data. As shown in FIG. 2, the display 101 includes a display panel 220, a controller unit (not shown) for controlling the display panel, and lenticular lenses 210 for providing stereoscopic display of images. The display 101 is an example of a display unit.

The display panel 220 is typically a plasma display panel or a liquid crystal display panel. The display panel 220 displays right eye images represented as “R” and left eye images represented as “L”. The right eye images and the left eye images are arranged alternately.

The lenticular lenses 210, which are convex lenses in cross section, are arranged in stripes. The lenticular lenses 210 can divide the optical path of light emitted from the display panel 220 into right eye images and left eye images. Through the lenticular lenses 210, the right eye images as “R” are recognized by the right eye of a user and the left eye images as “L” are recognized by the left eye of the user. The user can recognize the depth of an image because of parallax between the right eye image and the left eye image.

The operation part 110 receives an input from the user. The operation part 110 has buttons such as a four-way button capable of providing instructions for upward, downward, leftward, and rightward directions, an OK button, and a menu button. The user operates these buttons to select partially or entirely the region of an image on the display 101. In other words, the operation part 110 is an example of a receiving unit that receives an instruction for partially or entirely selecting the region of an image on the display 101.

The storage 120 is typically a recording medium, for example, a hard disk or a nonvolatile memory. In the storage 120, image data to be edited is accumulated. The image data includes stereoscopic image data and planar image data. The display 101 displays a stereoscopic image or a planar image based on the image data. A stereoscopic image is composed of, for example, two images (right eye image and left eye image) with lateral parallax. Typically, a stereoscopic image is subjected to irreversible compression using, for example, JPEG and is stored as a single file. Moreover, the storage 120 stores information edited by the image processor 140.

The memory 130 is an example of an acquisition unit that acquires image data from the storage 120. The memory 130 is a random access memory (RAM) that temporarily stores image data being edited. A region selected by the operation part 110 is partially or entirely stored in the memory 130 for a brief period.

The image processor 140 performs various kinds of image processing on stereoscopic images to be edited in the memory 130. The image processing is, for example, processing for editing the depth, color, brightness, position, and so on of stereoscopic images. The image processor 140 can generate an extracted image by extracting at least a partial image of the region of a first image that is selected by the operation part 110. The image processor 140 is an example of an extracting unit. Moreover, the image processor 140 can synthesize the extracted image with a second image that is different from the first image. The image processor 140 is an example of a synthesizing unit.

The controller 150 controls the components of the display apparatus 100 in an integrated manner. The controller 150 can switch an image displayed on the display 101 from stereoscopic display to planar display. Specifically, in the case where an image of acquired image data is displayed as a stereoscopic image on the display 101, the controller 150 controls the display 101 such that the image of the acquired image data is displayed as a planar image. For example, a stereoscopic image can be switched to planar display such that only a right eye image is displayed on the display 101. The controller 150 is an example of a control unit.

The main components constituting the display apparatus 100 are connected to one another via the bus 160 through which image data and various control signals are exchanged.

Referring to FIGS. 3A and 3B, the following will describe an example of the edit screen of the display apparatus 100 according to the present embodiment. FIG. 3A shows that any region of the first image is selected by a selection frame display 300. FIG. 3B shows that an image extracted from the first image is synthesized at any position of the second image. An image displayed on the display 101 of FIG. 3A will be referred to as the first image and an image displayed on the display 101 of FIG. 3B will be referred to as the second image.

The first image is an image of a person and the second image is a landscape image of a mountain. The present embodiment will describe a method of extracting the “person” contained in the first image and synthesizing the extracted image on the second image. The second image, which is an image for synthesis, is desirably captured by changing a stereo base in capturing according to the size of a subject and a distance from a camera to the subject. More preferably, the stereo base of the second image is larger than that of the first image. The stereo base is a distance between a lens for capturing a right eye image and a lens for capturing a left eye image. For example, in the case of a portrait image captured at close range (about 0.5 m to 3 m), a proper stereo base is about 10 mm to 50 mm. In the case where an image of a building or the like is captured at a distance of about 10 m, a proper stereo base is about 40 mm to 80 mm. In the case where an image of a larger object is captured at a longer distance, a proper stereo base is at least 70 mm.

As shown in FIGS. 3A and 3B, the operation part 110 includes operation parts 110a, 110b, and 110c. The operation parts 110a can provide instructions for upward, downward, leftward, and rightward directions. The operation part 110b is an OK button that provides an instruction for confirmation. The operation part 110c is an edit button for providing an instruction for starting the editing of an image.

The selection frame display 300 is an example of a display capable of specifying any region of an image. The selection frame display 300 appears when a user presses the operation part 110c. The user can move the selection frame display 300 to any position in the display 101 by means of the operation parts 110a.

Before the selection frame display 300 appears, that is, before the user presses the operation part 110c, a stereoscopic image is displayed on the display 101. When the user presses the operation part 110c, that is, at the start of a selecting operation, the stereoscopic image is switched to planar display. The user can select any region of the planar image by using the selection frame display 300. For example, when a person in an image is selected by the selection frame display 300 as shown in FIG. 3A, an image of the selected person is extracted. As shown in FIG. 3B, the extracted image is synthesized, for example, in the second image that is different from the first image displayed in FIG. 3A.

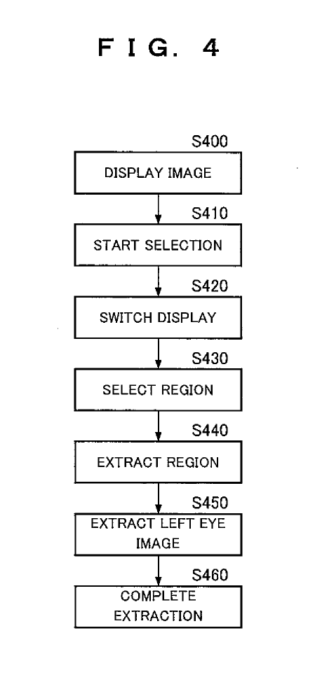

The following will describe a flowchart for generating a composite image by the display apparatus 100. FIG. 4 is a flowchart of selection and extraction of any region from the first image.

First, the first image is displayed stereoscopically on the display 101 (S400). The first image contains a region to be extracted by a user. A stereoscopic image file read from the storage 120 is separated into two images, that is, a right eye image and a left eye image. The images are subjected to image decoding in the image processor 140 and are stored in the memory 130. After that, the right eye image and the left eye image are reduced in size according to the resolution of the display 101, are subjected to thinning in view of the layout of the lenticular lenses 210, and then are properly synthesized in the image processor 140, so that the first image is displayed stereoscopically on the display 101. In the case where the storage 120 stores multiple stereoscopic image files, multiple stereoscopic images are displayed sequentially on the display 101 by operating the right and left operation parts 110a.

When the user presses the operation part 110c in a state in which the first image is displayed stereoscopically on the display 101, the selection (edition) of the first image is started (S410).

At the start of the selection (edition) of the first image, the display on the display 101 is switched from stereoscopic display to planar display (S420). Specifically, in stereoscopic display, an image obtained by alternately synthesizing the right eye image and the left eye image at each vertical line is displayed on the display 101, whereas at the start of the selection, only one of the right and left eye images is displayed on the display 101. For the sake of convenience, the right eye image is displayed in the present embodiment. The same image is viewed by the right and left eyes of the user, so that the displayed image is recognized as a planar image. Furthermore, the selection frame display 300 appears on the first image displayed as a planar image.

When the selection frame display 300 appears on the first image displayed as a planar image, the user selects a desired region of the first image with the selection frame display 300 (S430). The user vertically and horizontally moves the selection frame display 300 with the operation parts 110a and presses the operation part 110b, which is an OK button, so that the desired region of the first image can be selected. In the case where the user selects a desired region with the selection frame display 300, the region to be specified by the user is frequently larger than the size of the selection frame display 300. In other words, in many cases, only a part of a region to be selected by the user is specified. For example, when the user selects a human body from an image, the size of the human body displayed in the image is larger than the size of the selection frame display 300. In this case, it is preferable to select the overall human body by selecting a part of the human body with the selection frame display 300. Thus in the display apparatus 100 of the present embodiment, a region to be selected by the user is estimated based on an image region selected by the selection frame display 300, the estimated region is selected, and then the selected region is extracted. Specifically, in the case where the selection frame display 300 contains a human face, a human region containing the face is detected and a human body region is detected as a selected region. Alternatively, a region containing a surrounding similar region may be detected as a selected region based on color information or brightness information in the selection frame display 300, or the edge region of the selection frame display 300 may be extracted and a region surrounded by the edge of the selection frame display 300 may be detected as a selected region. Any region may be selected by any other known methods. Alternatively, some of the methods may be combined or one of the methods may be selected by the user. The image processing is performed in the image processor 140.

After any region of the first image is selected, the selected region is extracted (S440). The extracted image is the image data of the right eye image. In order to obtain the image data of the corresponding left eye image, an image region most similar to the extracted right eye image is extracted from the left eye image (S450). The image region can be extracted by known image processing operations such as template matching.

With this processing, an image region specified by the user can be selected and extracted in each of the right eye image and the left eye image. At the completion of the selection, the selection frame display 300 is erased and the display 101 is returned to stereoscopic display (S460).

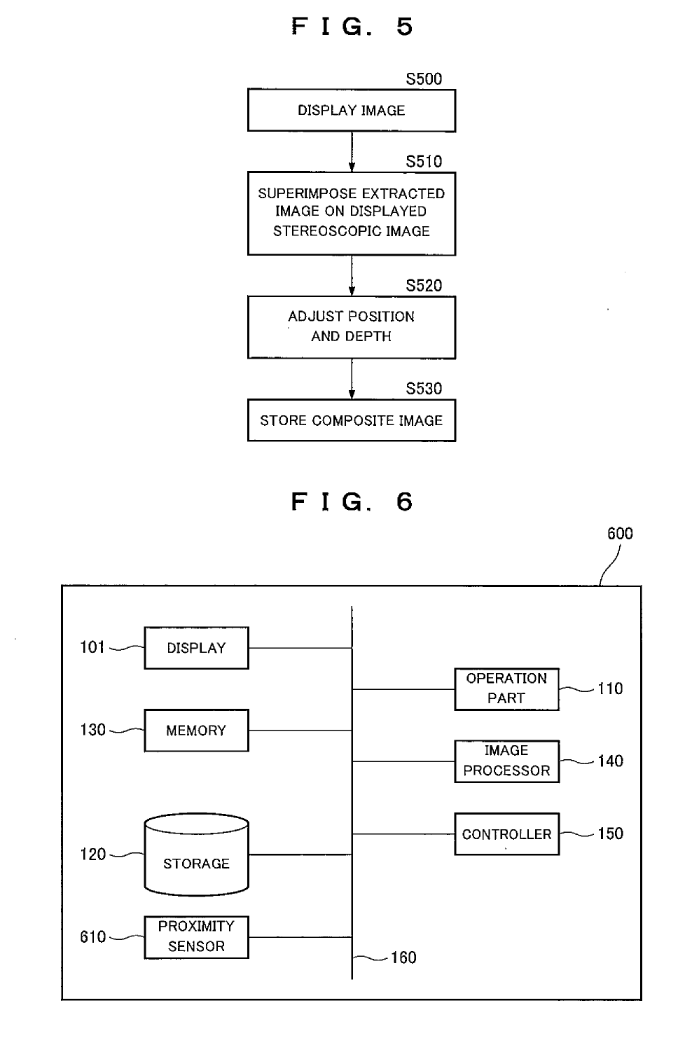

Referring to FIG. 5, the following will describe the synthesis of the extracted image onto the second image. FIG. 5 is a flowchart showing the synthesis of the extracted image onto the second image.

First, the second image different from the first image is stereoscopically displayed on the display 101 (S500). Processing contents and an operating procedure for displaying a desired stereoscopic image are similar to those of step S400.

When the second image, which is a synthesis object, is displayed on the display 101, the extracted image is superimposed on the second image (S510). Specifically, the extracted right eye image is superimposed at a predetermined position of the right eye image of the second image stereoscopically displayed on the display 101, while the extracted left eye image is superimposed at a predetermined position of the left eye image of the stereoscopic image displayed on the display 101. At this point, the extracted right and left eye images are superimposed at the same y-coordinate and different x-coordinates separated by a predetermined number of pixels. The separation by the predetermined number of pixels is an amount of separation that provides a stereoscopic image display at the closest proximity to the user.

After the extracted image is superimposed on the second image, the position and depth of the extracted image are adjusted (S520). First, the user optionally presses the operation parts 110a to move the extracted image to a desired position. When the user presses the operation part 110b, which is an OK button, the position of the extracted image is confirmed and then the depth of the extracted image can be adjusted. The user presses the upper or lower operation part 110a to increase or reduce the depth of the extracted image. The depth is increased or reduced by changing the amount of separation between the right eye image and the left eye image of the extracted image. At the completion of the adjustment to the depth, the user presses the operation part 110b, which is an OK button, to confirm the depth of the extracted image.

When the position and depth of the extracted image have been adjusted, the right eye image and the left eye image are compressed in the image processor 140 and are temporarily stored in the memory 130. The controller 150 combines the compressed right eye image and left eye image in the memory 130 into a single file, provides the file with header information including an image size, and then records the file in the storage 120. The file recorded in the storage 120 may contain the position information and depth information of the extracted image. A composite image is generated thus.

In the present embodiment, a stereoscopic image is switched to planar display when the user starts the selecting operation, allowing the user to naturally select any region of an image displayed on the display 101. Thus the user more easily can select and edit a stereoscopic image than in the related art.

Moreover, the position information and depth information of the extracted image are stored in the storage 120. Thus in the case where the extracted image is synthesized again onto another image, the images can be synthesized efficiently by using the information.

As has been discussed, an image of a person is extracted from the first image, which is a portrait image, and then the extracted image is synthesized onto the second image, which is a landscape image of a mountain or the like. In this case, the stereo base of the second image is more preferably larger than that of the first image. In the case where the first image of a person is synthesized thus onto the second image that is a background image of a building or a landscape, the stereo base during capturing of the second image is larger than the stereo base of the first image, so that a stereoscopic image of the person and the background image can be obtained. In other words, in the case where the stereo base during capturing of the second image is not larger than the stereo base of the first image, the image of the person hardly is viewed as a stereoscopic image. The configuration of the present embodiment can prevent such a problem.

### Second Embodiment

A display apparatus 600 according to a second embodiment will be described below. The same configurations as in the first embodiment will be indicated by the same reference numerals and an explanation thereof may be omitted.

FIG. 6 is a block diagram showing the configuration of the display apparatus 600 according to the second embodiment. The configuration of the display apparatus 600 is different from that of the display apparatus 100 of the first embodiment in that a proximity sensor 610 is provided. The proximity sensor 610 is capable of detecting the proximity of an object in a noncontact manner and includes an infrared emitting part and an infrared receiving part. Infrared radiation emitted from the infrared emitting part is reflected by the object and is received by the infrared receiving part. The proximity sensor 610 detects the proximity of the object depending upon the intensity of the infrared radiation received by the infrared receiving part.

A display 101 of the present embodiment can display stereoscopically an image by a field-sequential stereoscopic television system. Specifically, in this method, a left eye image and a right eye image are displayed alternately in each field period and the images are viewed with liquid crystal shutter glasses on which a left eye side and a right eye side alternately are opened and closed in synchronization with the field period of the display 101. The display panel of the display 101 includes a touch panel, so that the coordinates of a contact position can be detected on the display panel. Examples of the touch panel include, but not limited to, panels of capacitance type or inductive coupling type.

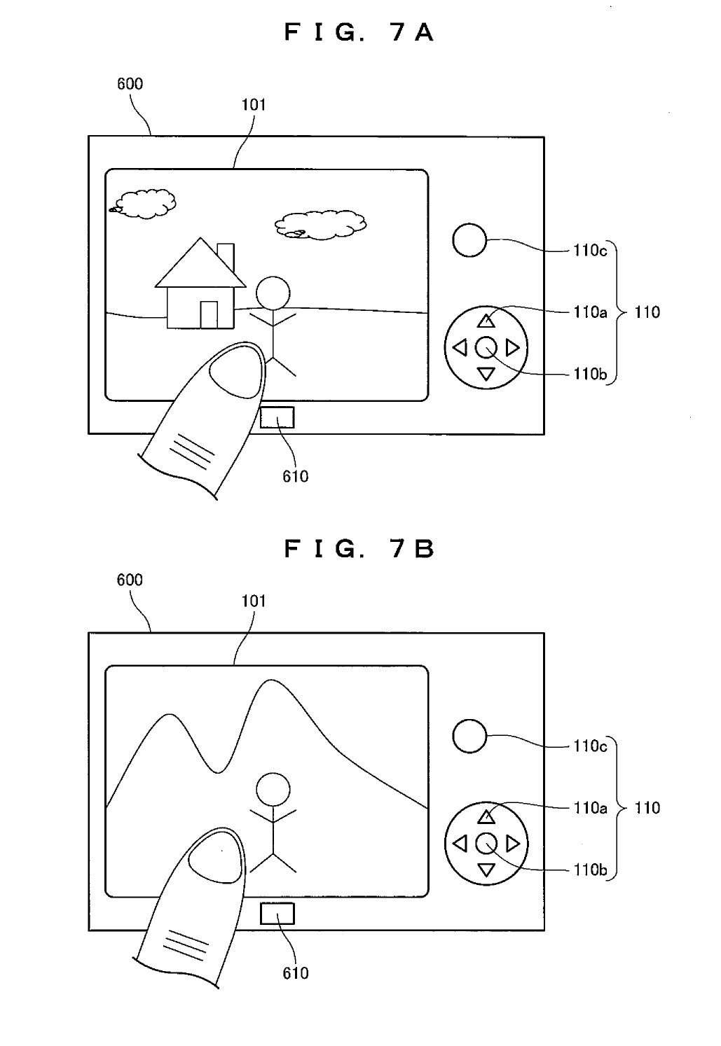

Referring to FIGS. 7A and 7B, the following will describe an example of an edit screen on the display apparatus 600 according to the present embodiment. In FIG. 7A, any region of a first image is selected by a finger of a user. In FIG. 7B, an image extracted from the first image is synthesized at any position of a second image. As in the first embodiment, the image on the display 101 of FIG. 7A will be referred to as the first image and the image on the display 101 of FIG. 7B will be referred to as the second image.

As shown in FIG. 7A, the proximity sensor 610 is disposed below the display 101. When the user's finger approaches the display 101, the proximity sensor 610 disposed near the display 101 detects the proximity of the finger. When the proximity of the finger is detected, stereoscopic display is switched to planar display. The user can select any region of the first image, which is a planar image, and extract the selected region. Then, as shown in FIG. 7B, the user can set the extracted image at any position of the second image.

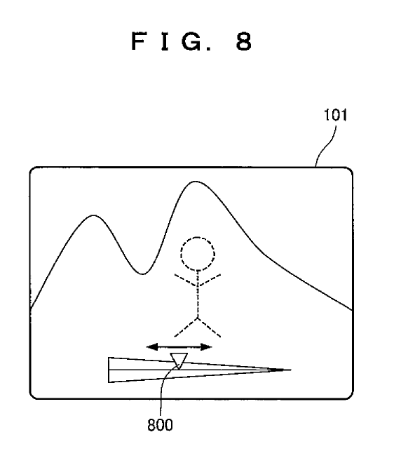

FIG. 8 shows an example of an operation screen for adjusting the depth of an image extracted by the display apparatus 600 of the present embodiment. On the display 101, the extracted image is superimposed on the second image.

As shown in FIG. 8, a depth adjusting slider 800 for adjusting the depth of the extracted image can be displayed on the display 101. The depth of the extracted image can be corrected properly by moving the depth adjusting slider 800 with a finger. For example, in the case where the depth adjusting slider 800 is slid to the left by a user's finger, the extracted image is displayed as if the image protruded relative to the user. In the case where the depth adjusting slider 800 is slid to the right by the user's finger, the extracted image is displayed as if the image retracted relative to the rear. A movement of the user's finger is detected by the touch panel and is reflected on the movement of the depth adjusting slider 800.

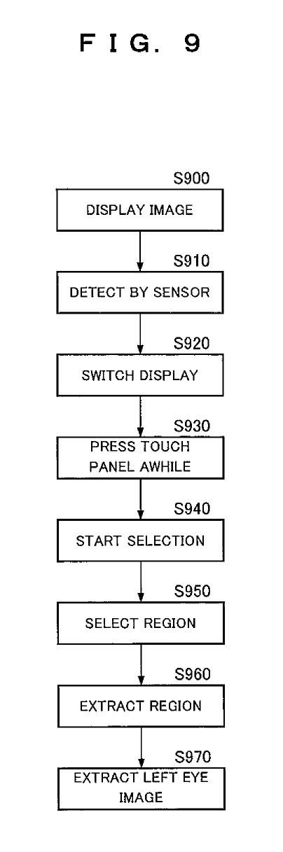

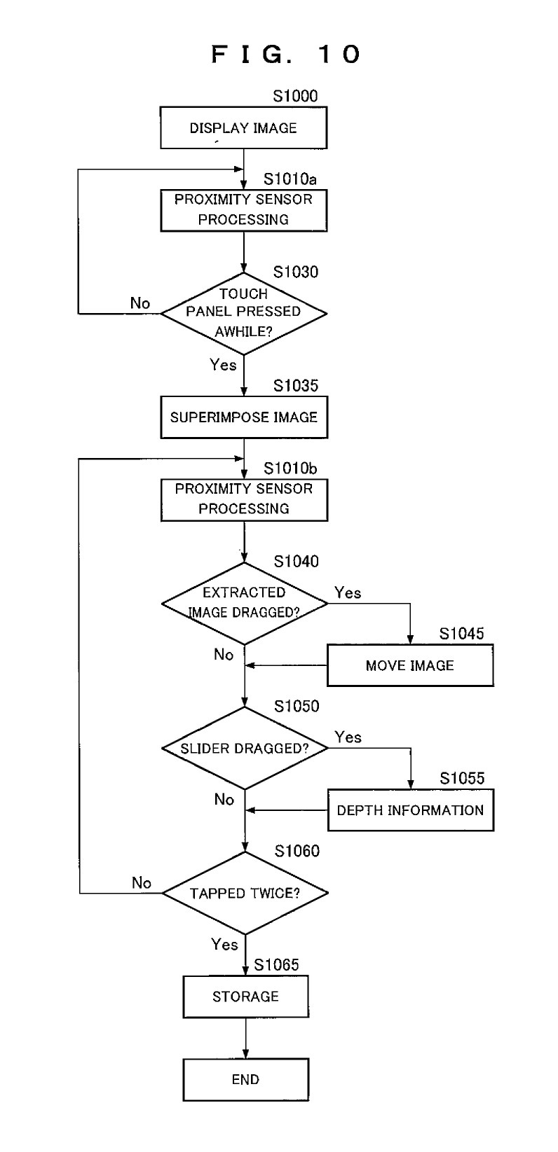

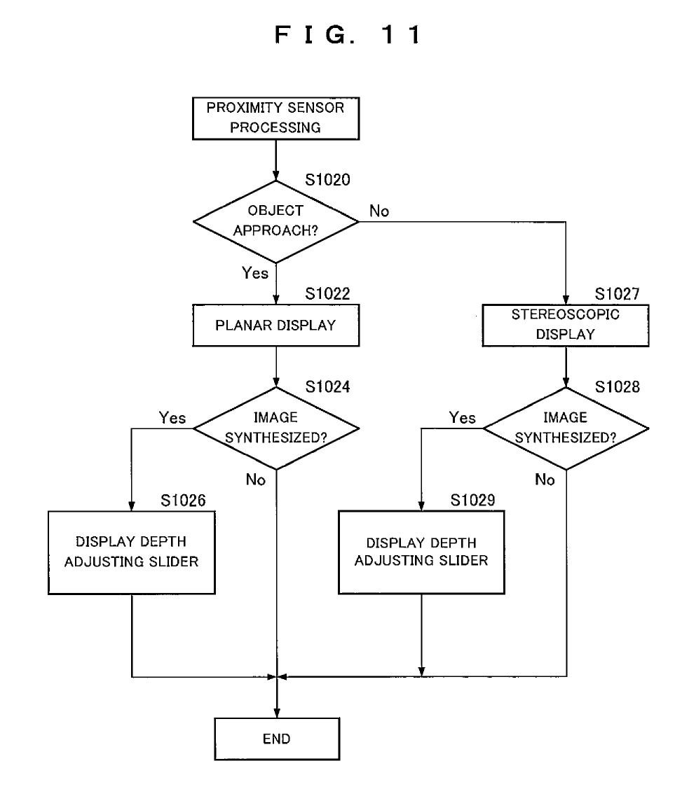

The following will describe the generation of a composite image in accordance with flowcharts. FIG. 9 is a flowchart of selection and extraction of any region from the first image. FIGS. 10 and 11 are flowcharts of synthesis of an extracted image on the second image.

As shown in FIG. 9, first, the first image is displayed stereoscopically on the display 101 (S900). The first image contains a region to be extracted by the user. A stereoscopic image file read from a storage 120 is separated into two images, that is, a right eye image and a left eye image. The images are subjected to image decoding in an image processor 140 and are stored in a memory 130. After that, the images are properly reduced in size according to the resolution of the display 101 by the image processor 140 and are displayed on the display 101.

When the user's finger approaches the display 101 in a state in which the first image is displayed stereoscopically on the display 101, the proximity sensor 610 detects the proximity of the finger (or hand) (S910). In the case of a reaction of the proximity sensor 610, the display 101 is switched from stereoscopic display to planar display (S920).

The touch panel displaying the first image as a planar image is pressed by the user for a while (S930), so that the user can start selection of a region (S940).

Next, the user selects a region (S950). Specifically, the user touching the touch panel traces the region to be selected with a finger, so that a selection region is formed. The finger is separated from the display 101 to confirm the selected region and extract the image of the region (S960). The extracted image is the image data of a right eye image. In order to obtain the image data of the corresponding left eye image, an image region most similar to the extracted image is extracted from the left eye image (S970). The image region can be extracted by known image processing operations such as template matching.

With this processing, an image region specified by the user can be selected and extracted in each of the right eye image and the left eye image. Referring to FIGS. 10 and 11, the following will describe the synthesis of the extracted image onto the second image. FIG. 10 is a flowchart showing the synthesis of the extracted image onto the second image. FIG. 11 is a flowchart for specifically explaining the processing of the proximity sensor.

First, as shown in FIG. 10, the second image different from the first image is displayed on the display 101 (S1000). Processing contents and an operating procedure for displaying a desired stereoscopic image are similar to those of step S900. When an image to be synthesized is displayed on the display 101, the proximity sensor 610 determines the proximity of an object such as a finger and a hand and the display contents of the display 101 are properly switched (S1010a). Referring to FIG. 11, processing in step S1010a will be specifically described below. First, the output of the proximity sensor is checked to decide whether an object such as a finger and a hand is close to the display 101 (S1020). In the case where the proximity sensor 610 decides that an object is close to the display 101, the display 101 is switched to planar display (S1022). After that, it is decided whether an extracted image has been synthesized or not on a planar image based on the flowchart of FIG. 9 (S1024). In the case where the extracted image has been synthesized, the depth adjusting slider capable of adjusting the depth of a composite image is displayed under the synthesized image (S1026) and then the processing is completed. In step S1024, in the case where the planar image has not been synthesized, the processing is completed without any additional processing.

In step S1020, in the case where the proximity sensor decides that no object has approached the display 101, the display 101 provides stereoscopic display (S1027). After that, it is decided whether an extracted image has been synthesized or not based on the flowchart of FIG. 9 (S1028). In the case where the extracted image has been synthesized, the process advances to step S1029 to erase the depth adjusting slider 800 that has been disposed under the synthesized image and is capable of adjusting the depth of a composite image (S1029), and then the processing is completed. In the case where the image has not been synthesized, the processing is completed without any additional processing.

After the completion of processing of the proximity sensor in step S1010a, the process advances to step S1030 to decide whether or not a touch has been continued for a certain period of time at the same position on the touch panel of the display 101 (S1030). In the case where a touch has been continued at least for a certain period of time at the same position on the touch panel of the display 101, the image extracted by the processing of the flowchart in FIG. 9 is superimposed on the second image stereoscopically displayed at this moment on the display 101 (S1035). The image is superimposed at the point of touch on the touch panel. Specifically, an extracted right eye image is superimposed on the right eye image of the second image and an extracted left eye image is superimposed on the left eye image of the second image. At this moment, the extracted right and left eye images are superimposed at the same y-coordinate and different x-coordinates separated by a predetermined number of pixels. The separation by the predetermined number of pixels is an amount of separation that provides stereoscopic image display in the closest proximity of the user.

In step S1030, in the case where a touch continued at least for a certain period of time at the same position is not detected, the process returns to step S1010a.

In step S1035, the extracted image is superimposed on the second image, and then the processing of the proximity sensor is performed (S1010b). The processing of step S1010b is similar to that of step S1010a and thus an explanation thereof is omitted. After the processing of the proximity sensor is completed, it is decided in subsequent step S1040 whether the image extracted and synthesized on the touch panel has been dragged or not (S1040). If it is decided that the image has been dragged, the process advances to step S1045 to change the position of the extracted image according to the dragging operation (S1045). In the case where the image has not been dragged, the extracted image is set at the superimposed position of step S1035.

After the positioning of the extracted image, it is decided whether the depth adjusting slider 800 has been dragged or not (S1050). If it is decided that the depth adjusting slider 800 has been dragged, the depth of the composite image is adjusted according to an amount of dragging (S1055). In the case where the depth adjusting slider has not been dragged, the extracted image is set with a depth set in step S1035 (in the closest proximity to the user).

After the depth of the extracted image is determined, it is decided whether the touch panel of the display 101 has been tapped twice (tapped twice with a finger) or not (S1060). If it is decided that the touch panel has been tapped twice, the position and depth of the extracted image are confirmed and the composite image is stored (S1065). In the case where the touch panel has not been tapped twice, the process returns to step S1010b.

In step S1065, first, the right eye image and the left eye image of the composite image are compressed by the image processor 140 and are stored temporarily in the memory 130. The controller 150 combines the compressed right and left eye images on the memory 130 into a file, adds header information including an image size to the file, and then records the file in the storage 120.

In the present embodiment, the proximity sensor detects the proximity of a user's finger or hand to switch stereoscopic display of an image to planar display, allowing the user to select naturally any region of an image displayed on the display 101. Thus the user can more easily select and edit a stereoscopic image than in the related art.

### Third Embodiment

In the foregoing embodiments, the display apparatuses each have the function of synthesizing and editing a stereoscopic image. The present invention is also applicable to a display apparatus not having an edit function. A display apparatus 1200 according to a third embodiment does not have an edit function. As in the second embodiment, a display 101 has a touch panel and a proximity sensor 610 that detects the proximity of an object is provided below the display 101. In other words, the display apparatus 1200 of the present embodiment is identical to the display apparatus 600 of the second embodiment except for the absence of an edit function and the provision of a display function for selection, as will be described later.

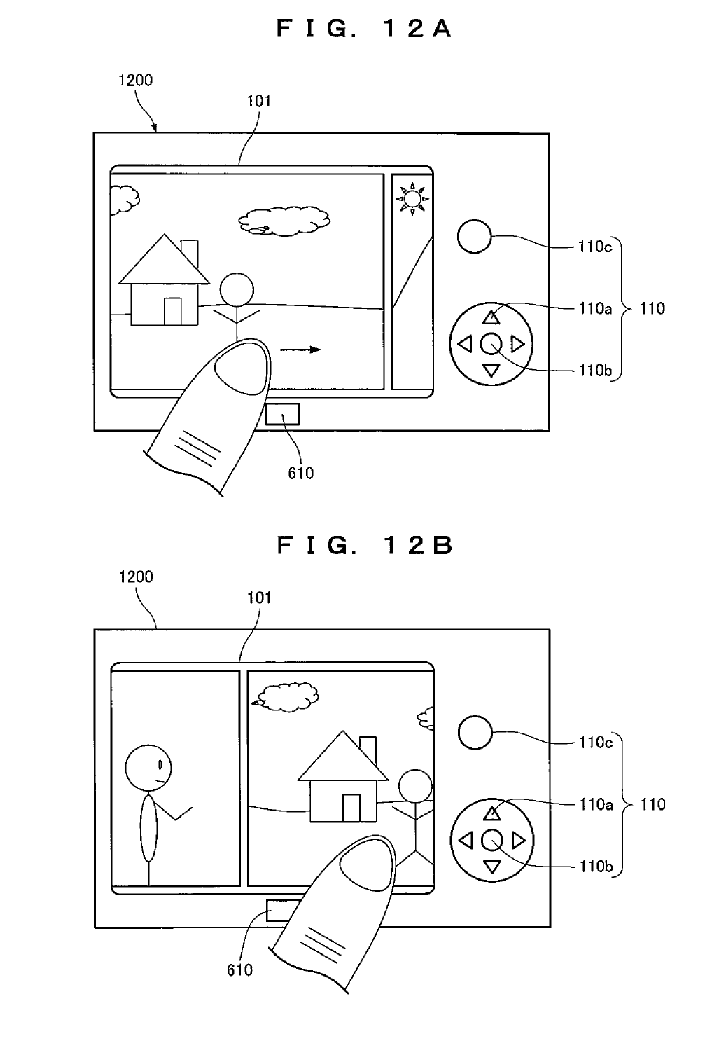

As shown in FIGS. 12A and 12B, the display apparatus 1200 of the present embodiment can switch images displayed on the display 101, in response to a movement of a finger from right to left or vice versa on the display 101. In other words, when a finger approaches the display 101, the proximity sensor 610 detects the proximity of a finger (or hand). While the proximity sensor 610 detects the proximity of a finger (or hand), stereoscopic display on the display 101 is switched to planar display. Specifically, alternate display of a left eye image and a right eye image in each field period is switched to display of the left eye image or the right eye image alone. In the present embodiment, a right eye image is displayed for convenience. The same image is viewed by the right and left eyes of a user, so that the image can be recognized as a planar image.

When the proximity of a finger (or hand) becomes undetectable by the proximity sensor 610, the display processing is changed to resume stereoscopic display of the image.

Also in the present embodiment, the proximity sensor detects the proximity of a user's finger or hand to switch a stereoscopic image to planar display, allowing the user to select naturally any region of an image displayed on the display 101. Thus the user can more easily select a stereoscopic image than in the related art.

In the present embodiment, the proximity sensor 610 is provided in addition to the display 101 having the touch panel. The proximity sensor 610 may be omitted. In this case, stereoscopic display on the display 101 may be switched to planar display while the proximity or contact of a finger (or hand) is detected on the display 101.

### (Summary)

The display apparatuses 100, 600, and 1200 of the foregoing embodiments each include: the memory 130 acting as an acquisition unit; the display 101 acting as a display unit; the operation part 110 acting as a receiving unit; and the controller 150 acting as a control unit. The memory 130 acquires image data stored in the storage 120. The display 101 displays an image of the acquired image data as a stereoscopic image or a planar image. The operation part 110 receives an instruction for selecting a part of the region of the displayed planar image. The controller 150 controls the display 101, in the case where the image of the image data acquired in the memory 130 is displayed as a stereoscopic image, such that the image of the image data acquired in the memory 130 is displayed as a planar image when an instruction for selection becomes receivable by the operation part 110.

With this configuration, a stereoscopic image is switched to planar display in response to the start of selection by a user, allowing the user to select naturally any region of an image displayed on the display 101. Thus the user can more easily select and edit a stereoscopic image than in the related art.

The display apparatuses 100, 600, and 1200 each include the image processor 140 acting as an extracting unit. Under the control of the controller 150, the image processor 140 specifies a region from a planar image displayed on the display 101, in response to an instruction for selection on the operation part 110. Moreover, the image processor 140 can extract image data used for displaying the specified region as a stereoscopic image, from the image data acquired in the memory 130. Furthermore, the image processor 140 can synthesize the extracted image data with another image data.

The display apparatuses 100, 600, and 1200 each include the operation part 110 and the depth adjusting slider 800 as adjusting units. The operation part 110 and the depth adjusting slider 800 adjust the depth of extracted image data in a state in which an image of synthesized image data is displayed as a stereoscopic image on the display 101. This configuration allows a user to easily edit a stereoscopic image by means of the operation part 110 and the depth adjusting slider 800.

The display apparatuses 100, 600, and 1200 each further include the storage 120 that acts as a recording unit for recording image data including an adjusted depth. With this configuration, in the case where image data including an adjusted depth is synthesized with another image data, images can be synthesized efficiently by using the information.

### Other Embodiments

In the first and second embodiments, the display apparatus is an apparatus for display and editing. The functions of the display apparatus are not limited to display and editing. As described in the third embodiment, the display apparatus may have the function of selection. The display apparatus installed on a digital still camera in the foregoing embodiments may be installed on a television, a recorder, a personal computer, a smartphone, a mobile phone, a tablet terminal, and so on.

In the second and third embodiments, the touch panel is operated with a user's finger or hand. The touch panel operation is not particularly limited. For example, the touch panel may be operated with a touch pen. In this case, the proximity of the touch pen may be detected by detecting electromagnetic induction between the touch pen and the panel, without using the proximity sensor.

In the second and third embodiments, in the case where a user's finger or hand approaches or comes into contact with the proximity sensor or the display, that is, at the moment of approach or contact, stereoscopic display is switched to planar display. Stereoscopic display may be switched to planar display when the approach or contact time exceeds a predetermined time.

In the second embodiment, the depth of an image is adjusted by operating the depth adjusting slider. The method of adjusting a depth is not particularly limited. For example, the user may press an image with a finger so as to adjust the depth according to the time or strength of the finger touch. The depth of an image may be adjusted by a so-called pinching operation. For example, an image pinched with two fingers of a user (so-called pinch-in) is displayed in the rear and an image touched with two fingers being separated from each other (so-called pinch-out) is displayed in the front.

In the third embodiment, an image on the display is switched from stereoscopic display to planar display depending upon the proximity of a finger moving from right to left or vice versa on the display. Additionally, when the user separates two fingers (pinch-out) to zoom in an image or pinches the image with two fingers (pinch-in), the proximity or contact of the fingers to the display may be detected to switch the image on the display from stereoscopic display to planar display.

Furthermore, an image on the display may be switched from stereoscopic display to planar display by shaking the display apparatus including an acceleration sensor, or recognizing a predetermined voice by means of a voice recognition unit included in the display apparatus.

In the foregoing embodiments, the display apparatus extracts a desired region from the first image and synthesizes the extracted region on the second image. Additionally, a third image, figures, and characters may be prepared and selected for synthesis with the first or second image. In this case, the third image and figures are recorded beforehand in the storage 120.

In the foregoing embodiments, the system utilizing the lenticular lenses and the field-sequential stereoscopic television system were illustrated as stereoscopic display methods. Other display methods may be used for stereoscopic display. For example, stereoscopic display may be provided by an anaglyph system for viewing video with glasses of red and blue color filters or a polarized glass system for viewing video with glasses of polarizing filters while projecting a right eye image and a left eye image in different polarization states.

In the foregoing embodiments, a stereoscopic image for synthesis is read from the storage. The configuration is not particularly limited. For example, an image may be acquired via the Internet. In the first and second embodiments, a part of the first image is selected and synthesized on the second image. Alternatively, the first image may be entirely selected and synthesized on a part of the second image.

In the foregoing embodiments, the display apparatus is an integrated unit. The present invention is not particularly limited to an integrated unit. For example, the display unit or the control unit may be provided separately.

The stereoscopic image display apparatus of the present invention is preferably applicable to, for example, digital still cameras, mobile phones, televisions, and personal computers.

What is claimed is:

1. A stereoscopic image display apparatus comprising:
an acquisition unit that acquires image data;
a display unit that displays an image of the acquired image data as one of a stereoscopic image and a planar image;
a receiving unit that receives an instruction for selecting at least a part of a region of the displayed planar image; and
a control unit that controls the display unit, in the case where the image of the image data acquired in the acquisition unit is displayed as a stereoscopic image on the display unit, such that the image of the image data acquired in the acquisition unit is displayed as a planar image when the instruction for selection becomes receivable by the receiving unit.

2. The stereoscopic image display apparatus according to claim 1, further comprising an extracting unit that specifies, according to the instruction for selection in the receiving unit, at least the part of the region of the planar image displayed on the display unit under control of the control unit, and extracts, from the image data acquired by the acquisition unit, image data for displaying at least the specified part of the region as a stereoscopic image.

3. The stereoscopic image display apparatus according to claim 2, further comprising a synthesizing unit that synthesizes the extracted image data with another image data.

4. The stereoscopic image display apparatus according to claim 3, further comprising an adjusting unit capable of adjusting a depth of the extracted image data in a state in which an image of the image data synthesized by the synthesizing unit is displayed as a stereoscopic image on the display unit.

5. The stereoscopic image display apparatus according to claim 4, further comprising a recording unit that records the image data including the depth adjusted by the adjusting unit.

6. The stereoscopic image display apparatus according to claim 1, further comprising a synthesizing unit that specifies, according to the instruction for selection in the receiving unit, at least the part of the region of the planar image displayed on the display unit under control of the control unit, and synthesizes image data different from the acquired image data with at least the specified part of the region.

7. The stereoscopic image display apparatus according to claim 1, wherein the stereoscopic image includes a right eye image and a left eye image with lateral parallax.

8. The stereoscopic image display apparatus according to claim 3, wherein in the case where the image of the image data acquired by the acquisition unit is displayed as a first image and an image of the other image data is displayed as a second image,
the first and second images are captured by a stereoscopic camera, and the first and second images are captured with different stereo bases.

9. The stereoscopic image display apparatus according to claim 8, wherein the stereo base for capturing the second image is larger than the stereo base for capturing the first image.
